(19) United States
(12) Patent Application Publication
(10) Pub. No.: US 2007/0189851 A1
(43) Pub. Date: Aug. 16, 2007

(54) Full interchange urban road system and the traffic method of using it

(76) Inventor: Dong Guoliang, GuangDong (CN)

Correspondence Address: WALLENSTEIN & WAGNER, LTD., 311 SOUTH WACKER DRIVE, 53RD FLOOR, CHICAGO, IL, 60606, US

(21) Appl. No.: 10/573,614

(22) PCT Filed: Oct. 24, 2003
(86) PCT No.: PCT/CN03/00892

§ 371 Date: Mar. 28, 2006

(30) Foreign Application Priority Data
Sep. 28, 2003 (CN) 03126464.6

(51) Int. Cl. E01C 1/00; G08G 1/095

(52) U.S. Cl. 404/1; 340/907

(57) ABSTRACT

The present invention relates to a full interchange urban road system and the traffic method of using it, characterized by that: the road system is a chessboard shaped double-layer road network. One layer is a motor way on the ground and another layer is a footway at a suitable elevation accordingly over the motor way. Alternatively, footways with proper width are located at each side above the two sides of the motor way, and the two side footways are connected across with a passageway, or part of a footway layer over an intersection of a collector street is constructed as a ring pathway or an aerial square. A turnaround passageway is designed between each two parallel expressways or under a separate fly-over type bridge arranged at an intersection of the two expressways. A minor arterial is provided between each of two parallel said expressways as a ramp for them and as a passageway leading to a subzone way. The system according to the invention separates pedestrians and vehicles, a great deal of road occupation area is saved, and full interchange for the expressways' crossings is achieved so that a crisscross expressway traffic system is established in the whole city as well as the problem of channelization is thoroughly resolved.

### TECHNICAL FIELD

The present invention relates to an urban road system and the traffic method of using it. More specifically, this invention relates to a full interchange urban road system for saving a great deal of road occupation area and the traffic method of using it. It belongs to the field of urban road and buildings.

### BACKGROUND OF THE INVENTION

With the improvement of the living standard of people, automobiles are more and more important. However, the sharp rise in the traffic volume causes serious traffic jams in urban traffic systems. The present traffic and road system comprises expressways for passing through more and more vehicles quickly and with the function of expediting traffic, major arterials for connecting the main districts or areas in a city and with the function of traffic, minor arterials for distributing traffic and with the function of services (i.e., to reach a destination), and collector streets for connecting minor arterial with residential quarters or neighborhoods and with the primary function of services. Generally, an isolating area is provided in the middle of major arterials for separating vehicles running in opposite directions, and vehicles and pedestrians are isolated in the major arterial by some means. The exit and entrance of public buildings for attracting people should not be positioned along the two sides of the major arterial. Minor arterials form the road network among the major arterials for improving the density of traffic. The traffic capacity of a residential quarter is diverted by major arterials and minor arterials through collector streets, the traffic capacity between adjacent residential clusters is diverted mainly by the major arterial in a city, and the traffic trips among residential clusters and in and out of the city are performed by the expressway. Though more and more over-crossings of interchange traffic, expressways of rotary type as well as ramps are built to relief the traffic congestion, it occupies too much land. The problems of serious traffic jams caused by the dramatically increased number of vehicles cannot be solved by the existing traffic pattern with the fast increase in the number of private automobiles.

CN 93119501.2 disclosed an urban stereo-traffic system, which constituted a modern urban road and traffic system comprising latticework formed by all urban roads orthogonal or un-orthogonal, preferably orthogonal. By this means, the city is divided into many blocks, residential quarters and plant areas. All roads constituting the latticework are one way only. In accordance with the principle of one-way only, a reversed road is provided between the two positive roads, on which vehicles run in opposite direction thereof. A single layer overcrossing is designed at the intersection of the two one way roads to form a high-layer stereo-traffic system. All roads are in closed form. Pavements for pedestrians, bicycles, jinrick-shaws and carriages are provided at the two sides of the one-way road (or they may be positioned at an elevation corresponding to the overcrossing, or under the ground). The railway or trolley car track is constructed near to and along the one-way, but with a safe distance or isolated by the residential quarter or pavement. The intersection of one-ways is connected with a half arc overcrossing for distribution or influx of vehicles. Each one-way comprises 3 lanes of traffic, among which one is for left turn, the middle one is for overtaking, and the third one is for right turn. Generally, no traffic light is provided on this stereo-traffic system, and vehicles keep flowing all the time. The public transport station is provided at the location of closed parapet of each side of the one-way, an entrance is designed for passengers, and buses park on the supplementary lane designated exclusively for bus stops.

The above stereo-traffic system can solve the problems for modern city traffic, and can greatly economize the investments used for building grade separation viaduct and signal systems and occupation areas. Said system is designed by using a one-way traffic principle, one-way ring road and overcrossing and turning principles. However, the disadvantages of this stereo-traffic system are: people need to circumambulate in order to get to the aimed terminal, so lot of time and energy may be wasted, and it is also inconvenient for trips. In addition, it is difficult to distinguish different roads. Moreover, this system occupied too much land.

CN 98107272.0 disclosed a cross facility, there is one isolating belt around the police station with inlets from and outlets to the roads in all directions. A road for motor vehicles to go straight and to turn left is provided inside the isolating belt; a road for motor vehicles to turn right and for pedestrians is provided outside it. Bicycles or pedestrians going straight and turning left pass through the upper or the lower layer subway bridge. The facilities are simple and economic. The interference between motor vehicles and bicycles at intersections can be reduced.

CN 97115611.5 disclosed a method for relief of traffic jams that features internal and external circular lanes defined in the center of road cross. The vehicles normally run along the internal circular lane. When the vehicles inside the internal circular lane reach a saturation point, forming a traffic jam, the vehicles outside the internal lane run along the external circular lane. As a result, the vehicles run in circumference to change the direction, and the traffic flow volume may increase.

CN 98117567.8 disclosed a design scheme for a building and traffic system suitable for a city or centralized residential area or expressway that features rooftops of buildings that are serially connected together to form highways, and an underground road or subway that is built under the buildings. Said two kinds of highway and underground road are connected to the highway on the land. An elevated railway may also be provided alongside the rooftops of the buildings. Compared with the existing traffic systems and buildings, the advantages of this technical solution are that the spaces above the buildings and underground are utilized sufficiently, and the resource of land is saved. However, the disadvantages of it are that it costs too much, it is difficult to realize, and it cannot meet the requirement of city view.

### SUMMARY OF THE INVENTION

The object of the present invention is to provide a full interchange urban road system to separate the motor vehicles from pedestrians and non-motor vehicles by occupying a limited coverage ratio of urban road area so that the vehicle flow capacity is improved, and the problems of traffic jams and congestion, difficulty in parking, and the separation of automobiles and pedestrians are thoroughly resolved.

The other object of the present invention is to provide a traffic method of using the above mentioned system to achieve vehicles driving at high speed and high efficiency by changing the existing urban expressways and major arterials fully into expressways without traffic lights or only using limited traffic lights.

In accordance with the first aspect of the present invention, there is provided a full interchange urban road system comprising roads for motor vehicles and traffic lanes for non-motor vehicle arranged in essentially a chessboard-shaped road network. The road system comprises a double-layer road structure. One layer is a motor way on the ground, and the other layer is a footway at a suitable elevation over the motor way. The width of the footway corresponds to the width of the motor way. Alternatively, footways with proper width are located at each side above the two sides of the motor way, or the two kinds of roads are both provided in an urban road system respectively.

Preferably, the footways (traffic lane for non-motor vehicles) are designed at each side above the two sides of the motor way. The footways between the two side are connected across with a passageway. Alternatively, part of the footway layer of collector streets or the intersection of footway layers is constructed as a ring pathway or aerial square.

When the footways (traffic lane for non-motor vehicles) are constructed over the two sides of the road layer for the motor way, the footways (traffic lane for non-motor vehicles) along the two sides are provided at the same level.

A parapet is employed along at least one side of the footways when the footways (traffic lane for non-motor vehicles) are designed over the two sides of the road layer for motor way.

The motor ways of the present invention comprise expressways and minor arterials, A separate fly-over type bridge is arranged at an intersection of the two expressways. The minor arterials perform the function of ramps at the fly-over bridge of the expressway. Therefore, the expressway and major arterial in the existing specification of the urban road system are changed into expressway entirely, and high speed and high efficiency traffic can be achieved.

A turnaround passageway is designed at an intersection of the two expressways or under a separate fly-over type bridge of expressways.

A minor arterial (branch arterial way) is provided between each two parallel expressways as a ramp for them or as a passageway for leading to sub-zone ways.

The first floor layers of the buildings on the ground and beside the two sides of the road are aerial layers that are used for parking areas, urban forestation, construction for means of transportation, as well as circumnavigating of vehicles under emergency.

The first floor layers of the buildings on the ground are aerial layers that are used for parking areas and urban forestation so as to improve the urban ventilation and relieve the heat island effect in city.

The shape of the above-mentioned chessboard-shaped road network can be changed properly into non-squares, and the road can be a linear or curved road.

There are branch roads at the boundaries of the city and in the city. For turning left, either a U-turn road or a special ramp is located near the branch road (T-shape road). Alternatively, a separate fly-over type bridge for left turns is designed at the branch road of the expressway. Moreover, the branch road is located on the minor arterial to avoid the branch road on the expressway, and this minor arterial is one way only to perform the function of an expressway.

The present invention also provides the traffic method of using the above-mentioned full interchange urban road system, in which the motorway comprises expressways and minor arterials. A separate fly-over type bridge is arranged at an intersection of the two expressways. Vehicles go straight or turn to the travel side along the travel direction on the expressway. The minor arterial performs the function of a ramp. Accordingly, no signal exists at the intersection of the two expressways, pedestrians and vehicles are separated thoroughly, and the travel speed is improved dramatically. Though vehicles need to circumnavigate on some roads, the travel time can be shortened due to the traffic flowing.

The above-mentioned vehicles go straight or turn to the travel side along the travel direction on the expressway. Thus, vehicles can only turn left on the expressway in a country or region where the traffic keeps to the left, and vehicles can only turn right along the travel direction on the expressway at a country or region where the traffic keeps to the right.

Right-turn only or routine management mode can be taken at the intersection between minor arterials.

Utilizing the above-mentioned technical solution, the major arterials in the prior arts are changed into expressways, the density of expressways is increased, and the minor arterials perform the function of a traditional ramp in the prior art and instead thereof. Meanwhile, turning to the opposite side of travel direction is forbidden, and no over-crossings of interchange traffic are built on the expressway, which leads to the results that the pedestrians and vehicles are separated, a great deal of road occupation area is saved, and full interchange for the expressways' crossings is achieved so that a crisscross expressway traffic system is established in the whole city as well as the problem of channelization is thoroughly resolved.

### BRIEF DESCRIPTION OF THE DRAWINGS

The present invention will become more apparent from the following detailed description taken in conjunction with the accompanying drawings, in which:

FIG. 1 is a plan view of the motorway of an urban road system in accordance with the present invention.

FIG. 2 is a schematic view of the motorway and footway of an urban road system in accordance with the present invention.

FIG. 3 is a schematic plan view of the footway (traffic lane for non-motor vehicles) of an urban road system in accordance with the present invention.

FIG. 4 is a schematic plan view of the road for turnaround of an urban road system in accordance with the present invention.

FIG. 5 is a schematic plan view of the branch road (T-shape road) in the motorway at the city boundary or in the city of an urban road system in accordance with the present invention.

FIG. 6 is a schematic view of a separate fly-over type bridge at the branch road on the expressway in accordance with the present invention.

### DETAILED DESCRIPTION

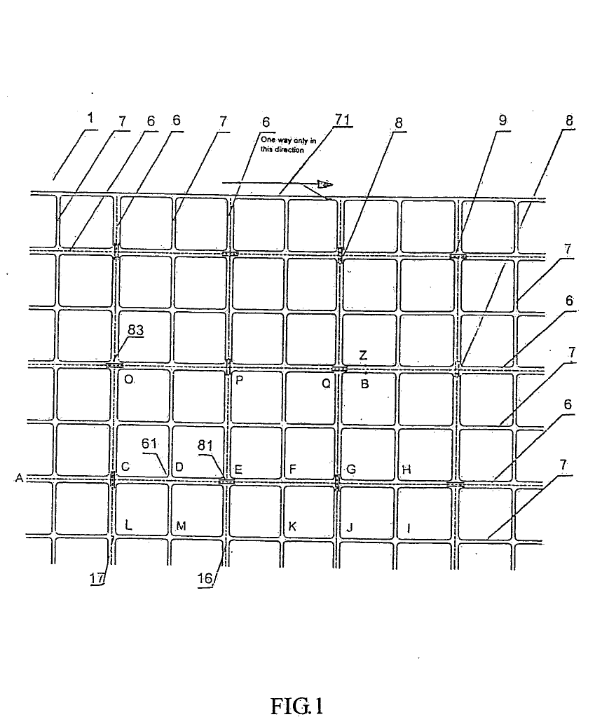

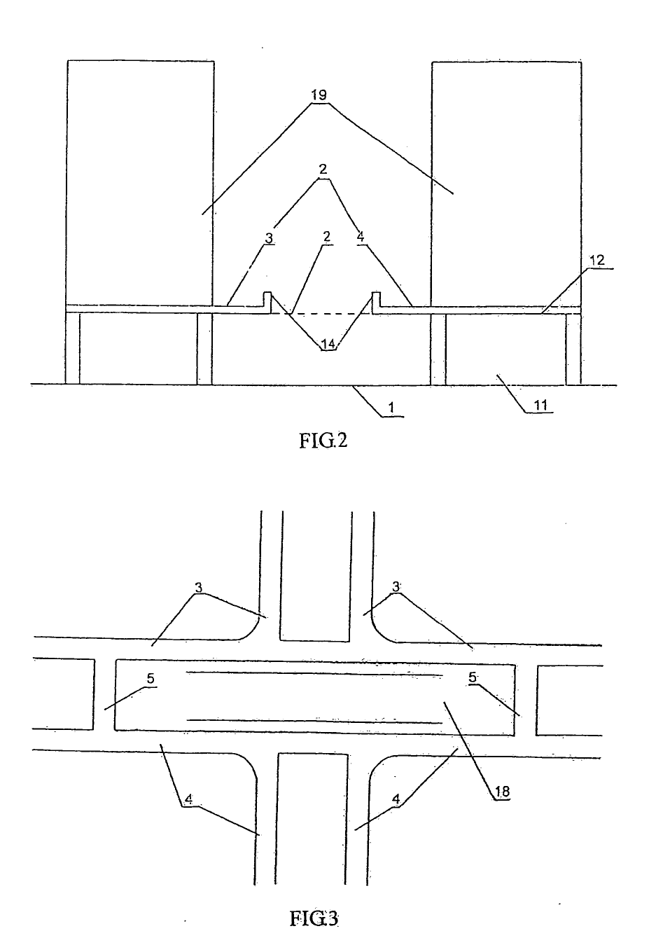

As shown in FIGS. 1-2, a full interchange urban road system of the present invention is essentially a chessboard-shaped road network, which comprises a road for motor vehicles 1 and a footway 2 that performs the function of a traffic lane for non-motor vehicles. The road system is comprised of a double-layer road structure. The motor way 1 of the first road layer is on the ground, and the second layer is footway layer 2 at a suitable elevation accordingly over the motor way 1. The width of the footway 2 corresponds to the width of the motor way 1, or the footways 3,4 with proper width are located respectively at each side above the two sides of motor way 1. Alternatively, the two kinds of road systems are employed in an urban road system respectively in one city. When the footways 3, 4 (traffic lanes for non-motor vehicles) are designed over the both sides of the driveway 1 (motor way), they are connected across with the passageway 5 (as shown in FIG. 3). The parapet 14 is employed along at least one side of footways 3 or 4. Part of the footway layer 2 of collector streets or the intersection of footway layer 2 is constructed as a ring pathway or an aerial square 18 (as shown in FIG. 3).

The motor way 1 comprises expressways 6 and minor arterials 7. One minor arterial 7 is built between two expressways 6 for performing as the ramp of expressway 6 and access to the collector street (driveway of residential quarter, not shown in the drawing).

A separate fly-over bridge type 9 is arranged at an intersection 8 of the two expressways 6. The minor arterials 7 perform the function of a ramp of the fly-over bridge for the motor way 1. The width of minor arterials 7 is generally narrower than that of expressways 6. Preferably it is L/2 width of that of expressways 6 so as to decrease the occupation for land. Meanwhile, the minor arterials 7 perform the function of a ramp of motor way 1. The separate fly-over type bridge 9 may be fly-over or tunnel mode. The alignment mode disclosed in the prior art for constructing the bridge in the vertical and horizontal direction can be chosen flexible, not limited with interlaced arrangement as shown in FIG. 1.

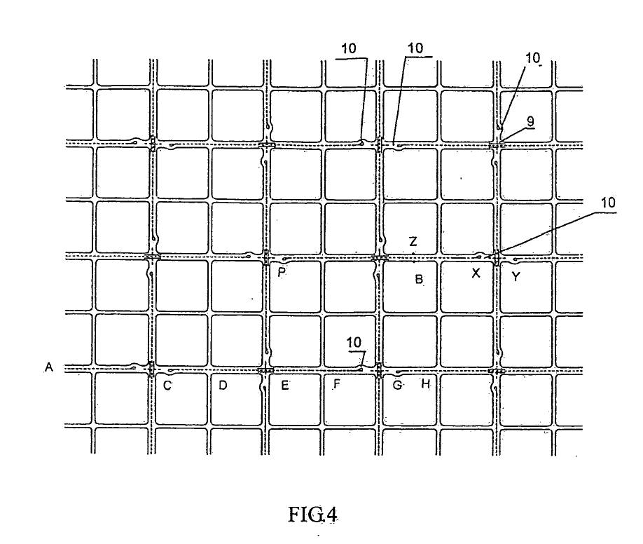

With reference to FIGS. 4 and 1, at least one turnaround passageway 10 is designed between or above the two intersecting expressways. A plurality of turnaround passageways 10 can be employed according to the length between intersections and the actual requirement so as to reduce the distance of circumambulating. In addition, a turnaround passageway may be designed under the separate fly-over type bridge 9 at the intersections 8, 81 of expressways 6 (not shown in the drawing).

The expressway 6 of the present invention may be constructed according to any kind of expressway disclosed in the prior art, the width of which is chosen to be several-way traffic.

The first floor of building 19 beside the expressway 6 and/or minor arterials 7 has aerial layers 11 that are formed between the ground and the building roof 12. The aerial layers 11 are used for parking areas, urban forestation, construction for means of transportation, as well as circumnavigating of vehicles under emergency. When the footway layer 3 or 4 is adjacent to the building, it is connected with the building roof 12 directly. It makes the travel convenient, and the parapet adjacent to the building may be omitted.

The first floor layers of the buildings on the ground are aerial layers that are used for parking areas, urban forestation so as to improve the urban ventilation and relieve the heat island effect in city.

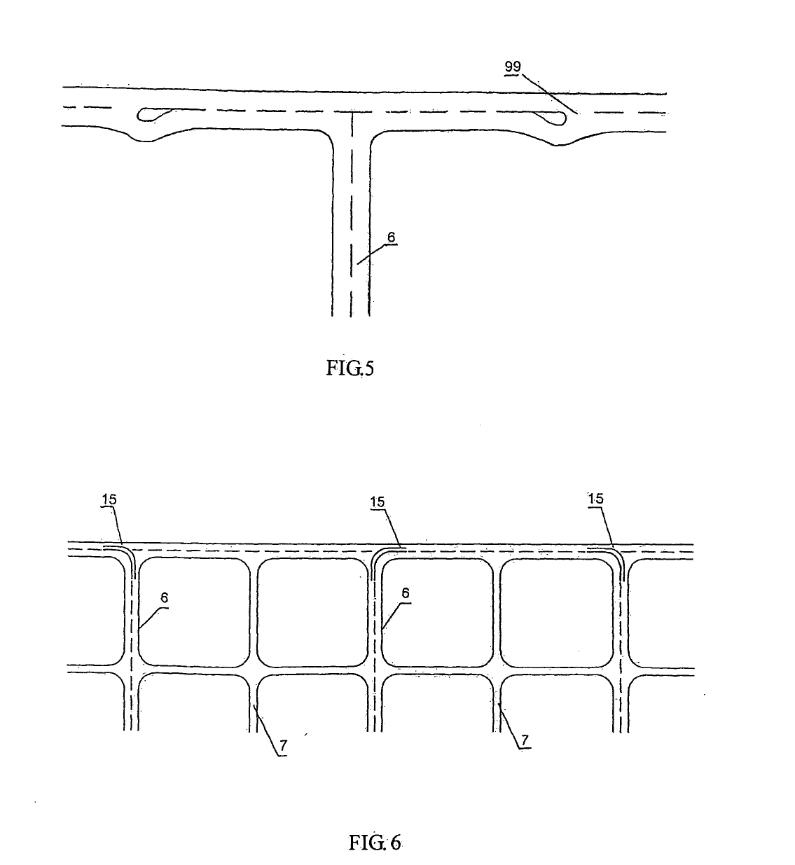

There are branch roads (T-shape roads) at the boundary of the city and in the city, such as locations near to railways, rivers and so on. For turning left, either a U-turn road (turnaround passageway) 99 or a particular ramp is located near the branch road (as shown in FIG. 5). Alternatively, a separate fly-over type bridge for left turns is designed at the branch road of the expressway (as shown in FIG. 5). Moreover, the branch road is located on the minor arterial 71 to eliminate the branch road on the expressway 6 as shown in the upper part of FIG. 1, and this minor arterial is one way only to perform the function of a ramp of the expressway.

Referring to FIG. 1, the traffic method of using the above-mentioned full-interchange urban road system comprises: if a vehicle departs from location of A to that of B, it may turn right at the location of D, the intersection 61 of expressway 6 and minor arterials 7. Due to no left turn on the expressway 6; it turns right at the location of M and turns right again when it proceeds to the crossroad 17 of minor arterials 7 (location of L). The vehicle goes ahead and turns right again at the location of O (83), then keeps straight on till to the location of B. The whole route is indicated as A-C-D-M-L-C-O-P-B. In this embodiment, the road from D to M to L acts as a ramp. Alternatively, the vehicle keeps straight on from location A to that of H, then arrives at the terminal B by passing through the crossroad of H, I, J, G and Q by keeping straight on and turning right continuously. In this case, the section of path G-H-I-J performs the function of a ramp. A vehicle may turn around at the turnaround passageway (10) located at F-G, and turns right at the crossroad of E and P respectively, then keeps straight on to terminal B in accordance with FIG. 4. No traffic light is on the expressway, so the driving speed is improved obviously.

Right-turn only or routine management mode can be taken at the intersection 16 or 17 between minor arterials 7.

If a vehicle departs from location of A to the terminal of Z opposite to the location of B, except the route mentioned above, it only needs to turn around at the turnaround passageway 10, then keeps straight on to the terminal Z. Any two locations in the city can be connected by above-mentioned routes.

For a country where the traffic keeps to the left, the vehicle turns left along the travel direction instead of the above right-turn.

The traffic system of the present invention solves the problem of traffic jams and congestion, difficulty in finding parking areas and the separation of pedestrians and vehicles under the urban planning of residential clusters. The time spent on road is shortened, and the traffic quality may not be affected by the expanding of urban scale. The interchange and overcrossing structures have the advantage of saving a great deal of coverage of urban road area. It is estimated that the capacity for vehicles may increase 3 to 4 times. The time taken for the same distance may shorten one time. The investment of urban road for each vehicle capacity may decrease one time. The fees for traffic control may reduce to ⅓ of the fees comparing the present invention with the existing road system under the existing coverage ratio of urban road area.

The traffic system and method of the present invention can be applied either into building a new city or the reconstruction of an old city. A new urban area according to the present invention may be designed bordering upon the old city during the old urban renewal, and the traffic capacity in the old city may be reduced gradually. Then the roads in the old city may be reconstructed step by step in accordance with the buildings' life times. In addition, the pavement may be built on stilts at a suitable elevation. Separate fly-over type bridges may also be provided and parts of minor arterials and collector streets may be used as ramps of separate fly-over type bridges so that the major arterials will change into expressways soon, and the traffic of the old city may be improved.

What is claimed is:

1-10. (canceled)

11. An interchange urban road system comprising:
a road for motor vehicles; and,
a traffic lane for non-motor vehicles arranged in essentially a grid-pattern road network with a double-layer road structure, in which one layer is a motor way on the ground and another layer is a footway at a suitable elevation above said motor way, wherein said footway is located, at least one of, over the motor way with the footway having a width substantially corresponding to the motorway, and/or above each side of said motor way wherein each of the sides of the footway are connected with a passageway.

12. An interchange urban road system of claim 11, wherein said motor way comprises an expressway and a minor arterial, wherein an over bridge is positioned at an expressway intersection, wherein said minor arterial is a ramp.

13. An interchange urban road system of claim 11, wherein at least a part of said footway layer proximate an intersection of a collector street is constructed as ring pathway or aerial square.

14. An interchange urban road system of claim 11, wherein said footways comprises a sidewalk and a traffic lane for non-motor vehicles provided at the same level.

15. An interchange urban road system of claim 11, wherein a turnaround passageway is positioned at least one or more of the following locations: an expressway intersections and/or under an over bridge of said expressways.

16. An interchange urban road system of claim 12, wherein a minor arterial is provided between two parallel expressways as a ramp for said parallel expressways and as a passageway to a subzone way.

17. An interchange urban road system of claim 11, 12, 13, 14, 15, or 16, wherein a plurality of buildings positioned on the ground and beside said sides of said road, each comprise a first floor layer at an aerial layer, wherein said first floor layer is provided for at least one of parking, urban forestation, transportation construction, and/or circumnavigating of said vehicles under emergency conditions; wherein said footways are connected with a roof of said first floor layer of said buildings, and wherein said aerial layer is provided for parking.

18. An interchange urban road system of claim 11, 12, 13, 14, 15, or 16, wherein at least one of a U-turn road and/or a special ramp within a city boundary, and/or an over bridge for a left turn, is provided proximate a branch road of said expressway, wherein said branch road is provided on the minor arterial.

19. An interchange urban road system of claim 11, wherein latticework of said essentially grid pattern road network is changeable in form, and wherein said road is at least one of a linear road and/or a curved road.

20. A traffic method of using the interchange urban road system of claim 11, 12, 13, 14, 15, 16, or 19, comprising an expressway and a minor arterial for constituting a motor way, an over bridge positioned at a location of an expressway intersection, wherein vehicles at least one of travel straight ahead and/or turn to a travel side, along a travel direction on the expressway, wherein vehicles can only turn left on the expressway in a region where traffic keeps to the left, wherein vehicles can only turn to the right along the travel direction on the expressway at a region where the traffic keeps to the right, and wherein said minor arterial is a ramp.
